(19) United States
(12) Patent Application Publication
(10) Pub. No.: US 2021/0114528 A1
(43) Pub. Date: Apr. 22, 2021

(54) VEHICLE ROOF RACK SYSTEM

(71) Applicant: Steve NEVENER, Centennial, CO (US)

(72) Inventor: Steve NEVENER, Centennial, CO (US)

(21) Appl. No.: 17/073,919

(22) Filed: Oct. 19, 2020

Related U.S. Application Data
(60) Provisional application No. 62/916,670, filed on Oct. 17, 2019.

(51) Int. Cl. B60R 9/048; B60R 9/10; B60R 9/12; B60R 9/045

(52) U.S. Cl. CPC B60R 9/048; B60R 9/045; B60R 9/12; B60R 9/10

(57) ABSTRACT

A vehicle roof rack system includes a body member, a flexible rack attachment member, and a connecting strap. The body member has at least one support surface arranged to support an object to be mounted to a vehicle. The flexible rack attachment member extends from the body member. A cavity is defined between the body member and the rack attachment member, and the cavity is sized to removably receive a portion of cross-bar of the vehicle. The connecting strap is connected to the rack attachment member and configured to wrap around a portion of the object supported on the at least one support surface. Tightening the connecting strap flexes the rack attachment member to apply a compression force that secures the vehicle roof rack system to the cross-bar.

### RELATED APPLICATIONS

This application claims priority to U.S. Provisional Patent Application No. 62/916,670, filed 17 Oct. 2019, pending and entitled “Vehicle Roof Rack System,” the disclosure of which is incorporated, in its entirety, by this reference.

### TECHNICAL FIELD

The present disclosure relates generally to vehicle roof racks and devices to secure objects to cross-bars on a roof of a vehicle, and more particularly to vehicle roof rack systems that connect to such cross-bars and provide attachment of objects to the vehicle via the cross-bars.

### BACKGROUND

Vehicle equipment racks used to mount bicycles, skis and other outdoor recreation equipment typically include a structure that is mounted on a vehicle, such as to the existing roof rack of the vehicle or to the tail hitch of the vehicle. While most vehicle equipment racks facilitate relatively quick and easy mounting and dismounting of the equipment, installing and removing the equipment rack itself can take considerable time and effort. Thus, users often leave this type of rack on their vehicle when the rack is not in use. In their mounted position on the vehicle, most vehicle racks protrude from the vehicle and thereby increase the overall dimensional footprint of the vehicle, causing hazards when pulling into enclosed areas such as parking garages, and increased drag that leads to reduced fuel efficiency. Vehicle racks also pose a threat of being stolen.

Thus, there is a need for a vehicle mounting rack that addresses these and other shortcoming of existing vehicle mounting racks.

### SUMMARY

The present disclosure is directed to a rack system used to secure an object to a vehicle. One aspect of the present disclosure relates to a vehicle roof rack system that includes a body member, a flexible rack attachment member, and a connecting strap. The body member has at least one support surface arranged to support an object to be mounted to a vehicle. The flexible rack attachment member extends from the body member. A cavity is defined between the body member and the rack attachment member, and the cavity is sized to removably receive a portion of cross-bar of the vehicle. The connecting strap is connected to the rack attachment member and configured to wrap around a portion of the object supported on the at least one support surface. Tightening the connecting strap flexes the rack attachment member to apply a compression force that secures the vehicle roof rack system to the cross-bar.

The connecting strap may include a quick release or adjustable buckle. The cavity may have a U cross-sectional shape. The at least one support surface may include at least one planar surface and the object is at least one set of snow skis, at least one snowboard, at least one surfboard, or other object with a planar or otherwise flat surface (e.g., a tool, lumber, ladder, or sports- or outdoor-related equipment). The at least one support surface may include at least one contoured surface and the object is an oar, a grippable handle, a pole, a pipe, or a tube. The at least one support surface may be sized and configured to support a bicycle tire or a bicycle wheel and the object may be a bicycle. The at least one support surface may be sized and configured to support a fishing rod or fishing rod case. The at least one support surface may be sized and configured to support hardware, tools, construction/building materials, or a variety of other objects use for home improvement, yard work, landscaping, maintenance projects, or the like. The body member and rack attachment member may include a polycarbonate material. The body member and rack attachment member may have an integral, single-piece construction. The rack attachment member includes a plurality of elongate gripping protrusions. The rack attachment member may include at least one through bore, and the connecting strap may extend through the at least one through bore. The rack attachment member may include a first end connected to the body member and a second free end spaced apart from the body member at an opening into the cavity. The rack attachment member may include at least one through bore positioned at the second free end, and the connecting strap may extend through the at least one through bore. The at least one support surface may include first and second support surfaces spaced apart laterally from each other. The body member may include retention portions positioned adjacent to the at least one support surface and arranged to restrict lateral movement of the object supported on the at least one support surface.

Another aspect of the present disclosure relates to a vehicle roof rack system that includes a body member, a rack attachment member, and a connecting member. The body member has at least one support surface arranged to support an object to be mounted to a vehicle. The rack attachment member ha a first end connected to the body member and a second end spaced apart from the body member to define a cavity between the body member and the rack attachment member. The cavity is configured to receive a cross-bar of the vehicle. The connecting member is connected to the rack attachment member and configured to engage the object supported on the at least one support surface. The connecting member applies a force that secures the object to the vehicle roof rack system and secures the vehicle roof rack system to the cross-bar.

A further aspect of the present disclosure relates to a method of mounting an object to a vehicle roof rack system. The method includes positioning a portion of a vehicle cross-bar in a cavity of the vehicle roof rack system, positioning the object on a support surface of the vehicle roof rack system, and securing the object to the vehicle roof rack system with a connecting member and simultaneously releasably securing the vehicle roof rack system to the vehicle cross-bar with the connecting member.

The vehicle roof rack system may include a body member, a rack attachment member, and a connecting member, the rack attachment member extending from the body member to define the cavity, the connecting member connected to a free end of the rack attachment member, and securing the object to the vehicle roof rack system may include wrapping the connecting member around the object and applying a tension force. Applying the tension force releasably may secure the vehicle roof rack system to the vehicle cross-bar, and releasing the connecting member may permit the vehicle roof rack system to be detached from the vehicle cross-bar. The connecting member may include a strap and adjustable buckle, and tightening the strap with the adjustable buckle may apply a tension force. The cavity may be open in a direction facing rearward when the vehicle roof rack system is mounted to the vehicle cross-bar.

Another aspect of the present disclosure relates to a method of mounting a vehicle roof rack system to a vehicle cross-bar. The method includes inserting a portion of vehicle cross-bar in a rearward facing opening of a cavity of the vehicle roof rack system, positioning an object to be mounted to the vehicle cross-bar on a support surface of the vehicle roof rack system, and securing the vehicle roof rack system to the vehicle cross-bar by securing the object to the vehicle roof rack system.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a perspective view of an example vehicle roof rack system in accordance with the present disclosure.

FIG. 2 is a perspective view of another example vehicle roof rack system in accordance with the present disclosure.

FIG. 3 is another perspective view of the vehicle roof rack system shown in FIG. 2.

FIG. 4 is a side view of the vehicle roof rack system shown in FIG. 2.

FIG. 5 is a cross-sectional view of the vehicle roof rack system shown in FIG. 2 taken along cross-section indicators 5-5.

FIG. 6 is a top view of the vehicle roof rack system shown in FIG. 2.

FIG. 7 is a front view of the vehicle roof rack system shown in FIG. 2.

FIG. 8 is a rear view of the vehicle roof rack system shown in FIG. 2.

FIG. 9 is a perspective view of another example vehicle roof rack system in accordance with the present disclosure.

FIG. 10 is a rear view of the vehicle roof rack system shown in

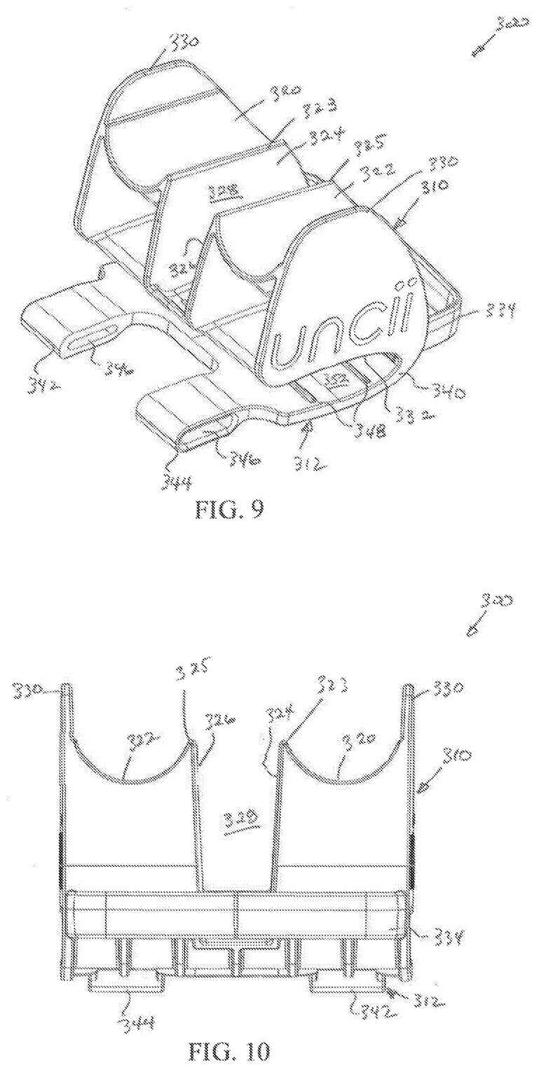

FIG. 9.

FIG. 11 is a perspective view of another example vehicle roof rack system in accordance with the present disclosure.

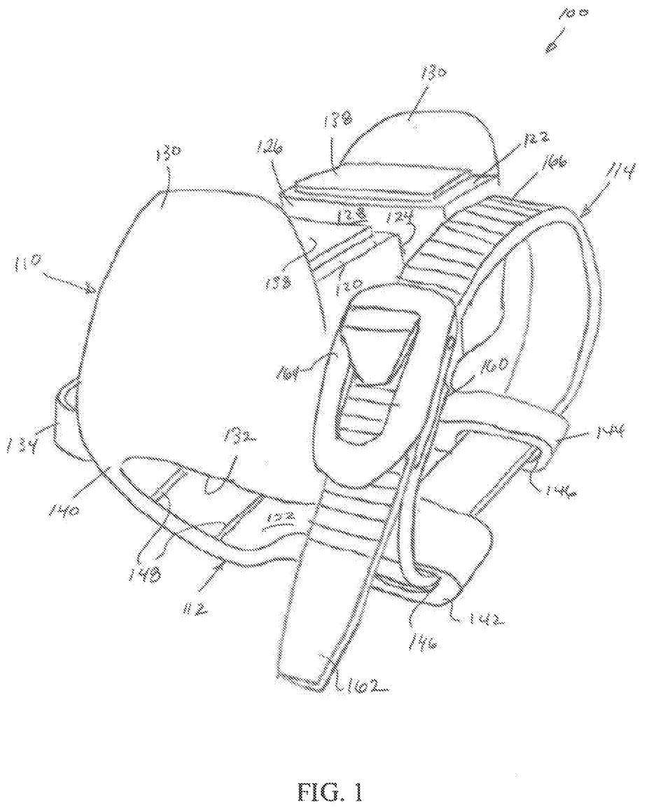

FIG. 12 is a perspective view of the vehicle roof rack system shown in FIG. 1 mounted to a vehicle cross-bar in a first mounting arrangement.

FIG. 13 is a perspective view of the vehicle roof rack system shown in FIG. 1 mounted to a vehicle cross-bar in a second arrangement.

FIG. 14 is a perspective view of another example roof rack system in accordance with the present disclosure mounted to a pair of vehicle cross-bars and in use securing an object to the vehicle.

FIG. 15 is a flow chart showing steps of an example method in accordance with the present disclosure.

FIG. 16 is a flow chart showing steps of another example method in accordance with the present disclosure.

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements without altering the invention itself.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

The present disclosure is directed to rack devices used to secure objects to a cross-bar on a roof of a vehicle. The racks, rack devices, rack components, and rack systems disclosed herein, as well as the related methods of use and assembly of such racks and rack systems, may provide advantages as compared to existing racks and rack systems. For example, the rack systems disclosed herein may provide for securing the rack system to the vehicle cross-bar and detaching the rack system from the cross-bar in a simply, relatively quick way. The rack systems disclosed herein may slide into place on the cross-bars and be secured to the cross-bars simultaneously with securing the object being mounted (e.g., a set of skis) to the rack system. The rack system can be disconnected from the cross-bars by releasing the object from the rack system and then sliding the rack system off the cross-bars.

Vehicles with cross-bars usually include two cross-bars that extend across the width of the vehicle along the top surface of the vehicle. The cross-bars are typically spaced apart along the length of the vehicle, may each have fixed positions along the length of the vehicle, or may be adjustable along the length of the vehicle. The cross-bars typically provide a secure mounting structure to which a rack system is mounted for the purpose of securing objects to the roof of the vehicle. Existing rack systems are mounted to the vehicle cross-bars with fasteners that require extensive time and effort to use. Most rack systems are intended to be mounted to the cross-bars independent of mounting an object (e.g., set of skis) to the vehicle. That is, after removing the object from being mounted to the cross-bars using the rack system, the rack system itself remains connected to the cross-bars. Such existing rack systems have several disadvantages as noted in the Background section above.

The rack systems disclosed herein provide advantages as compared to known systems and devices for at least the reason that the rack system is removable from the cross-bars on the vehicle roof when removing or as part of the process of removing the object from being attached to the vehicle. As such, it is possible to easily detach the rack system from the vehicle cross-bar and store it in a safe place (e.g., within the vehicle itself) and avoid the typical otherwise laborious task of mounting and dismounting the rack system when using fasteners or other more permanent mounting features.

One aspect of the present disclosure is directed to a vehicle roof rack system that includes a body member, a rack attachment member, and a connecting strap or other connecting member. The connecting member concurrently secures an object to the vehicle roof rack system as well as providing a connecting function that secures the vehicle roof rack system to the vehicle cross-bars. Thus, by operating the connecting member, two separate functions occur simultaneously: securing the object to the vehicle roof rack system and to the vehicle, and securing the vehicle roof rack system to the vehicle cross-bars.

An example vehicle roof rack system as disclosed herein may include a cavity that is defined between the body member and rack attachment member and that is sized to releasably receive one of the vehicle cross-bars. The vehicle roof rack system is able to slide onto the cross-bar and then be secured to the cross-bar when securing the object to the vehicle roof rack system. The cavity may have a U or V cross-sectional shape. In one example, the cavity has an opening facing in a rearward direction and the vehicle roof rack system is mounted to the vehicle cross-bars by sliding the roof rack members into this cavity (e.g., moving the body member and rack attachment member in a rearward direction while inserting the cross-bar into the cavity). Typically, the cavity is sized to accommodate a variety of different sizes and shapes of vehicle cross-bars. The interface between the cross-bar and the surfaces that define the cavity provide sufficient resistance to hold the vehicle roof rack system in a predefined orientation while mounting the object to the vehicle roof rack system. Once the object is supported on the vehicle roof rack system, the connecting member may be wrapped around a portion of the object and secured to the rack attachment member, thereby providing a positive connection between the object and the vehicle roof rack system. Operating the connecting strap to secure the object to the vehicle roof rack system also concurrently tightens the body member and roof attachment member onto the vehicle cross-bar with sufficient force to provide a positive connection therebetween. The connection between the vehicle roof rack system and the cross-bar become more secure as the connecting strap is made tighter around the object.

The connecting member may include an adjustable strap, a buckle, bracket or other feature that provides relatively quick and easy adjustability of the tension applied by the connecting member, as well as attachment and detachment of the object from the vehicle roof rack system. In at least some arrangements, the object is disconnected from the vehicle roof rack system prior to disconnecting the vehicle roof rack system from the cross-bars.

The object to be connected/disconnected using the vehicle roof rack systems disclosed herein may be any of a variety of physical object, without limitation to the shape, size, weight, or other physical properties or intended use of the object. Some example objects include, without limitation, sports equipment, outdoor recreation equipment, construction materials, construction or other tools, furniture, and the like. Although the objects are in most cases inanimate object, it may be possible to use the vehicle roof rack systems disclosed herein to detachable secure animate or living objects to a vehicle. Furthermore, although the vehicle roof rack systems disclosed herein are intended primarily for use with vehicles, other applications are possible such as on trailers, boats, recreational equipment, and other mobile objects, as well as with stational structures such as homes, commercial buildings, sheds, warehouses, hospitals, manufacturing facilities, and the like.

Referring now to FIG. 1, an example vehicle roof rack system 100 is shown and described. The vehicle roof rack system 100 includes a body member 110, a rack attachment member 112, and a connecting strap 114. The connecting strap 114 is sized to wrap around or otherwise connect to at least a portion of an object that is supported on the body member 110. A cavity is defined between the body member 110 and the rack attachment member 112 to receive a portion of a vehicle cross-bar that extends laterally across the width along the roof of the vehicle. The cavity may be sized to receive other portions of a vehicle or accessories mounted to a vehicle beside a cross-bar positioned on the roof of a vehicle.

The body member 110 includes horizontal support surfaces 120, 122, vertical support surfaces 124, 126, and a gap 128 positioned between the support surfaces 124, 126. Body member 110 also includes retention portions 130, a bottom surface 132, and a handle 134. Pad members 138 or similar structures may be positioned on any of the support surfaces 120, 122, 124, 126, or along the bottom surface 132. The pad member 138 may be positioned at an intended interface with the object that is being mounted to the vehicle using the vehicle roof rack system, or the interface between the vehicle roof rack system 100 and the existing roof rack of the vehicle. The pad members 138 may comprise a dampening or protecting material such as rubber, foam, or fabric.

The body member 110 may support an object on the horizontal support surfaces 120, 122. The retention portions 130 may help retain the object on the horizontal support surfaces 120, 122 at least in a lateral, side-to-side direction. In other arrangements, the object may be inserted between the vertical support surfaces 124, 126. In one example, the object is a set of snow skis that are supported on the horizontal support surfaces 120, 122 and have a width that fits between the retention portions 130. Alternatively, the snow skis may be rotated and then inserted between the vertical support surfaces 124, 126. Other relatively thin objects such as a snowboard turned on its side or a smaller diameter object may be sized to fit between the vertical support surfaces 124, 126.

The rack attachment member 112 may include an attachment end 140, first and second free ends 142, 144, a through bore 146, and lateral gripping protrusions 148. The attachment end 140 may be secured to the body member 110, such as along the bottom surface 132 or adjacent thereto. The first and second free ends 140, 142 extend away from the attachment end 140 and away from the body member 110. In at least some arrangements, the rack attachment member 112 is formed as an integral, single piece with the body member 110. In some examples, the body member 110 and rack attachment member 112 are formed using a molding process and a polymer material such as polycarbonate. In one example, at least some portions of the vehicle roof rack system comprise a polymeric material with percentage volume of glass fibers. Other manufacturing processes and materials may be used to form the body member 110 and rack attachment member 112.

The through bore 146 may be formed in the first and second free ends 142, 144. The through bore 146 may be sized to receive the connecting strap 114 extending therethrough. The connecting strap 114 may be connected to the body member 110 and rack attachment member 112 via the through bore 146 at the first and second free ends 142, 144. The connecting strap 114 may wrap around or otherwise be connected to a portion of an object that is supported on the body member 110.

Applying a tension force in the connecting strap 114 may move the rack attachment member 112 toward the object and toward the bottom surface 132 of the body member 110. When the vehicle rack member is inserted into a cavity 152 defined between the body member 110 and the rack attachment member 112, applying tension in the connecting strap 114 while wrapped around or connected to an object supported on the body member 110 reduces a size of the cavity 152, thereby applying a force that secures the vehicle roof rack system 100 to the vehicle cross-bar. In this tightened arrangement, the vehicle roof rack system 100 and the object are secured to the vehicle cross-bar with sufficient force and via a positive connection that should prevent the vehicle roof rack system 100 and the object from being disconnected from the vehicle cross-bar, subject to failure of the connecting strap 114.

The connecting strap 114 may include first and second free ends 160, 162, a buckle 164, and a plurality of latching surfaces 166 formed on the surface of the connecting strap 114 along its length. The connecting strap 114 may be referred to as a ladder strap and be configured for use with a ratchet type buckle 164. The connecting strap 114 may be fed through the through bore 146 of at least one of the first and second free ends 142, 144 of the rack attachment member 112. The buckle 164 is mounted to the first free end 160. The second free end 162 is fed through the buckle 164. The connecting strap 114 may be tightened by pulling on the free end 162 while holding the buckle 164 in a fixed position. Alternatively, the buckle 164 may include a ratchet or other tightening feature, which when operated tightens the connecting strap 114. A variety of different buckles 164 may be used, any of which typically provides a function of maintaining whatever tension is applied in the connecting strap 114 when tightening the connecting strap 114 around a portion of the object that is supported on the body member 110. The buckle 164 is typically operable to release the tension force in the strap 114.

Other types of connecting members may be used in place of the connecting strap 114. For example, a simple rope may be used and the free ends of the rope can be tied in a knot. Other examples include a cable, a zip tie, or the like.

While the rack attachment member 112 is shown including separate first and second free ends 142, 144, other embodiments may include a unitary, single free end positioned opposite to the attachment end 140. The use of one single free end may have advantages as compared to a split free end as shown in FIG. 1. However, the use of first and second free ends 142, 144 may provide certain advantages depending on the size, shape, and type of object supported on the body member 110. Other arrangements include more than two free ends for the rack attachment member 112.

Generally, the rack attachment member 112 has a cantilever-type arrangement relative to the body member 110. The rack attachment member 112 may be referred to as a flexible member that is movable and/or deformable, at least in part, thereby adapting to the shape and/or size of any given cross-bar to which the vehicle roof rack system 100 is mounted. The flexible and/or deformable properties of the rack attachment member 112 may also provide certain advantages related to application of the compression force applied to one or both of the objects being supported by the body member 110 and/or the cross-bar to which the vehicle roof rack system 100 is mounted. Other embodiments may be possible in which the cavity 152 is sized and shaped for a specific sized and/or shaped cross-bar of the vehicle. The rack attachment member 112 may have a more rigid, less deformable configuration in some embodiments.

The lateral gripping protrusions 148 may be provided along the rack attachment member 112 and/or along the bottom surface 132 of the body member 110. The gripping protrusions 148 may provide concentrated points of contact between the vehicle roof rack system 100 and the vehicle cross-bar, thereby potentially providing a more secure connection therebetween. Any number of lateral gripping protrusions 148 may be used. The lateral gripping protrusions 148 may have any desired shape and size. In some embodiments, no lateral gripping protrusions 148 are provided.

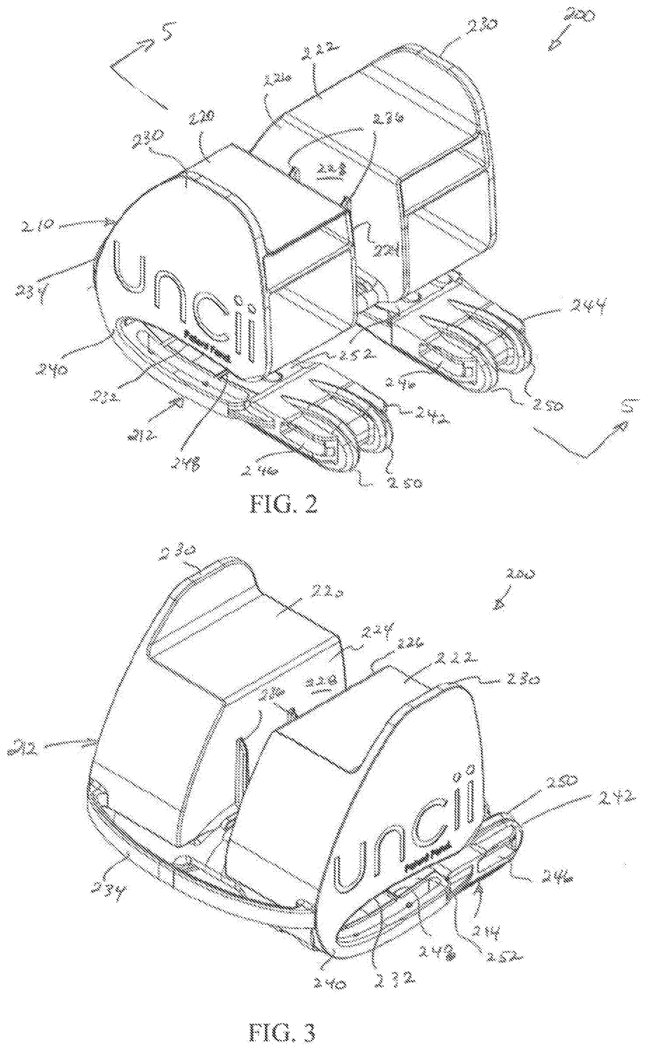

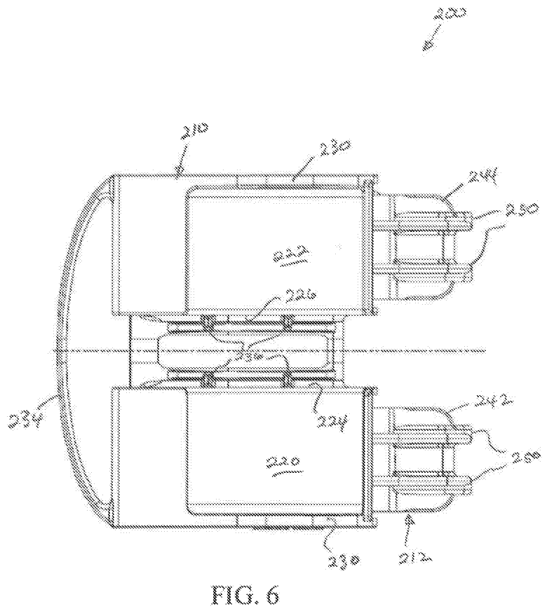

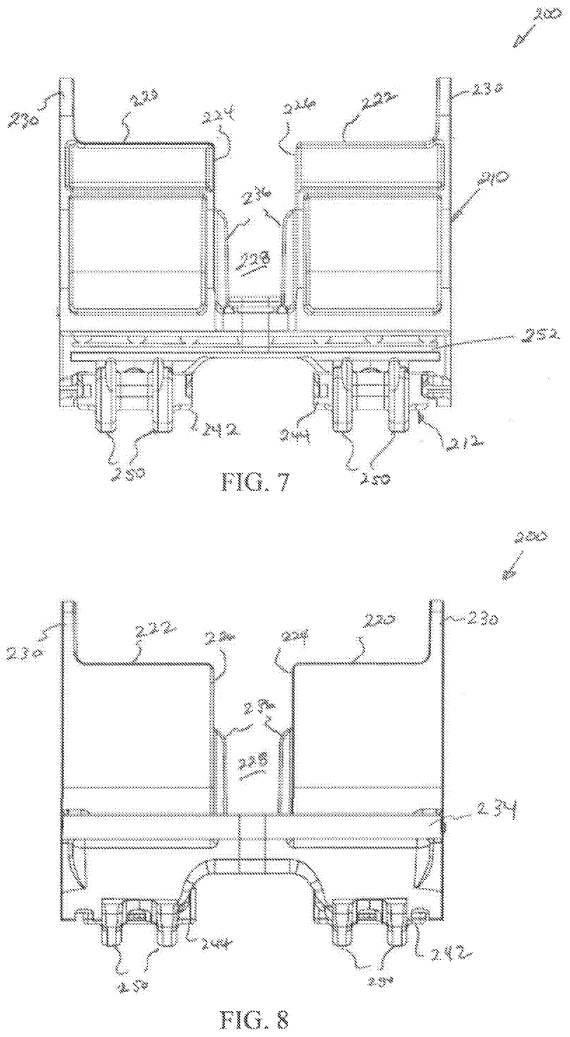

FIGS. 2-8 illustrate another example vehicle roof rack system 200. The vehicle roof rack system 200 includes a body member 210 and a rack attachment member 212. The body member 210 includes horizontal support surfaces 220, 222, vertical support surfaces 224, 226, a gap 228, retention portions 230, a bottom surface 232, a handle 234, and support protrusions 236. The rack attachment member 212 includes an attachment end 240, first and second free ends 242, 244, a through bore 246, lateral gripping protrusions 248, and longitudinal gripping protrusions 250. Many of the features and functions of the vehicle roof rack system 200 may be the same or similar to those described above with reference to vehicle roof rack system 100.

The body member 210 may have a generally hollow construction while still providing similar strength and rigidity as a body member having a more solid construction. Providing the body member 210 with a generally hollow construction may have advantages related to manufacturability, reduction of costs, reduced weight, and reduced shrinkage or deformation during molding processes. The body member 210 may include support protrusions 236 positioned along any of the support surfaces 220, 222, 224, 226. The support protrusions 236 may have an elongate structure. The support protrusions 236 may comprise a different material than the remaining portions of the body member 210. Similar to the pad members 138 described above, the support protrusions 236 may provide a bumper or low-friction interface, and may be deformable thereby providing an improved interface with the object supported by the body member 210.

The rack attachment member 212 may include lateral gripping protrusions 248 positioned within the cavity 252 along surfaces of the rack attachment member 212 and/or along the bottom surface 232 of the body member 210. The longitudinal gripping portions 250 may be arranged along a length dimension of the rack attachment member 212 rather than across the width or lateral dimension of the rack attachment member 212 (i.e., the arrangement of the lateral gripping protrusions 248). The longitudinal gripping protrusions 250 may be positioned along an upward-facing surface of the rack attachment member 212 so as to interface with the vehicle cross-bar while inserting the cross-bar of the vehicle into the cavity 252. The longitudinal gripping protrusions 252 may wrap around the first and second free ends 242, 244. The longitudinal gripping protrusions 250 may include similar cushioning, bumper-type material as the support protrusions 236 and/or the pad members 138. The longitudinal gripping protrusions 250 may provide an improved interface between the vehicle roof rack system 100 and the roof surface of the vehicle and/or other portions of the vehicle while mounting and dismounting the vehicle roof rack system 100 relative to the vehicle. The generally rounded, contoured shape of the first and second free ends 242, 244 and the longitudinal gripping protrusions 250 may promote easier mounting and dismounting of the vehicle roof rack system 100 relative to the vehicle (i.e., when sliding the vehicle roof rack system 100 onto and off of the cross-bar).

The handle 234 may be formed integral with the body member 210 and/or with the rack attachment member 212. The handle 234 may promote easier handling of the vehicle roof rack system 200 such as during mounting and dismounting of the vehicle roof rack system relative to the vehicle cross-bar, as well as storing the vehicle roof rack system 200. The handle 234 may be used to help maneuver the vehicle roof rack system 200 relative to the cross-bar of the vehicle when mounting and dismounting relative to the vehicle. The handle 234 may also be used for carrying and/or storing the vehicle roof rack system 200.

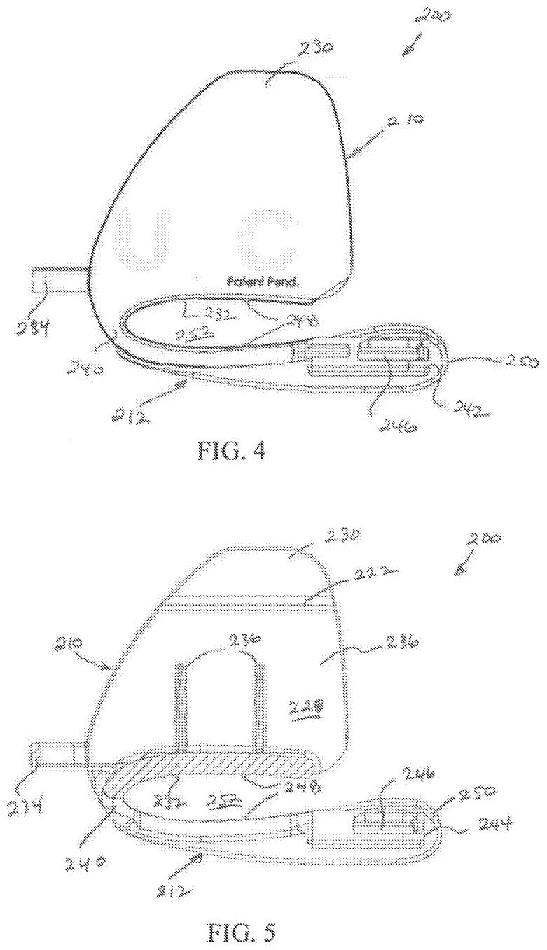

The through bore 246 may have a cross-sectional shape as shown in at least FIGS. 4 and 5 that is wider than it is tall. Other shapes and sizes are possible for the through bore 246, particularly to accommodate different sized and shaped connecting members that may be used with the vehicle roof rack system 200. For example, the generally rectangular cross-sectional shape shown in FIGS. 4 and 5 may be well suited for the relatively thin cross-sectional shape of the connecting strap 114 described above. A circular cross-sectional shape for the through bore 246 may be better suited for a rope or cable type connecting member.

The size of the gap 228 may be modified to accommodate or be customized for use with particular objects. The width, or spacing between the retention portions 230 may be customized to accommodate specific sized or shaped objects that are supported on the horizontal support surfaces 220, 222. Similarly, the spacing between the rack attachment member 212 and the bottom surface 232 of the body member 210 may be modified to provide a cavity 252 having a desired shape or size to accommodate specific shapes or sizes of the cross-bar inserted therein.

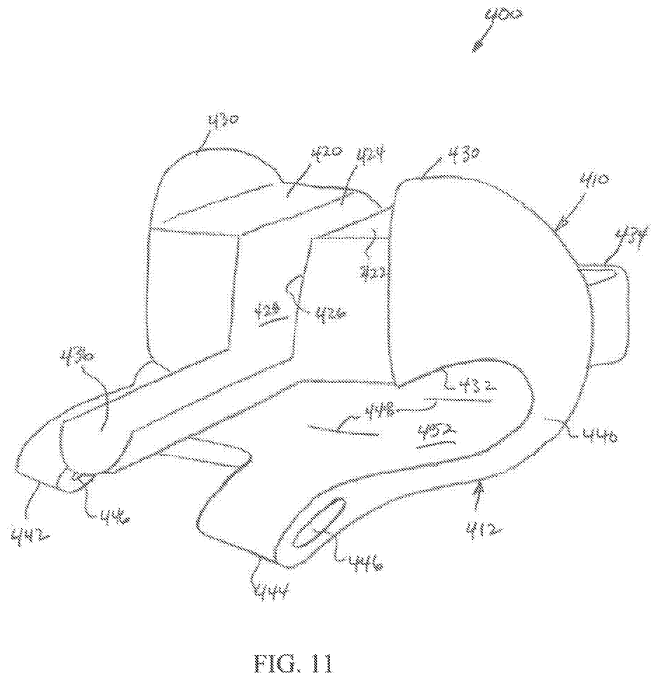

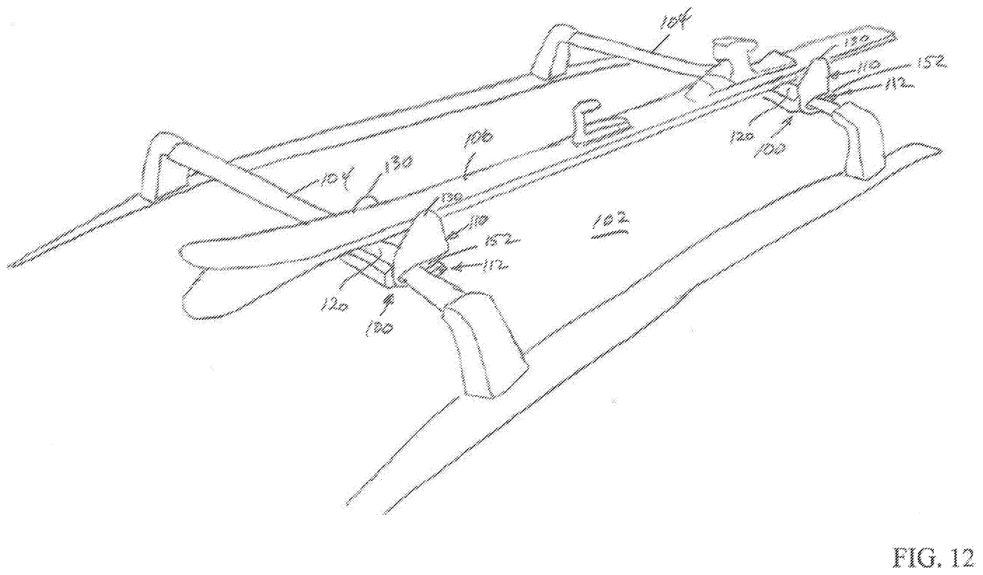

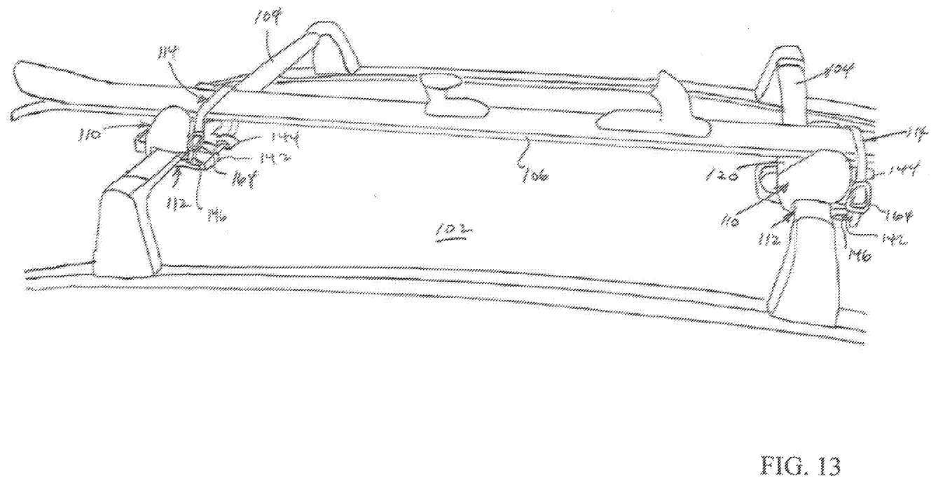

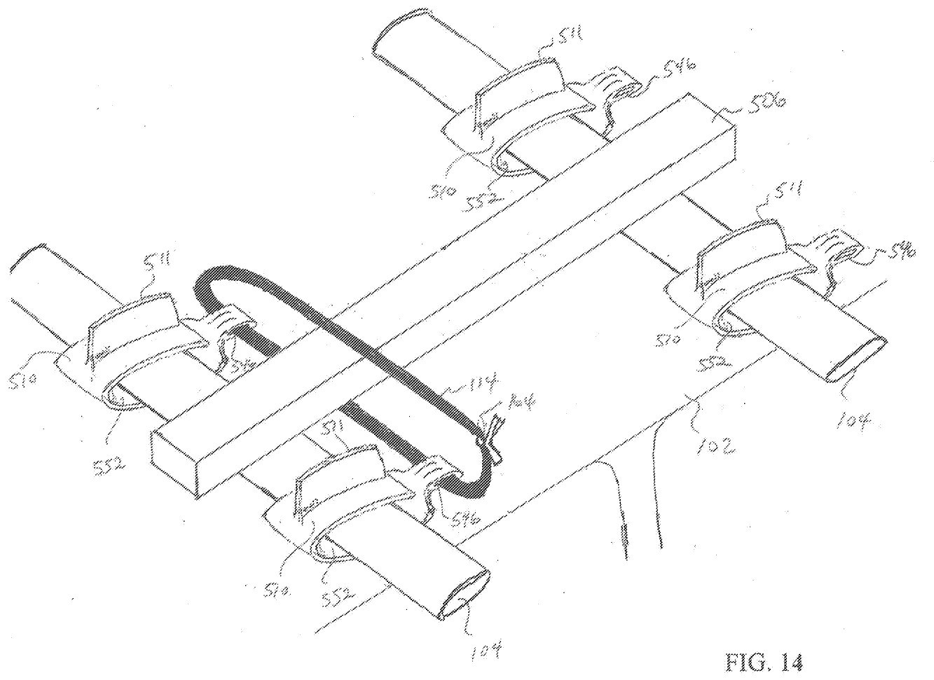

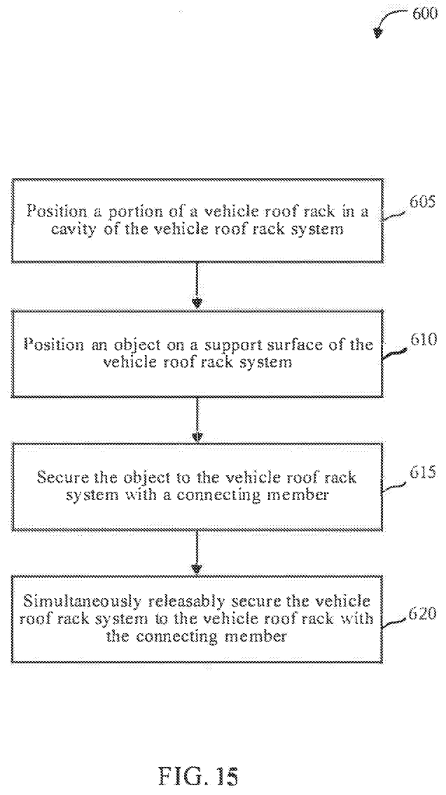

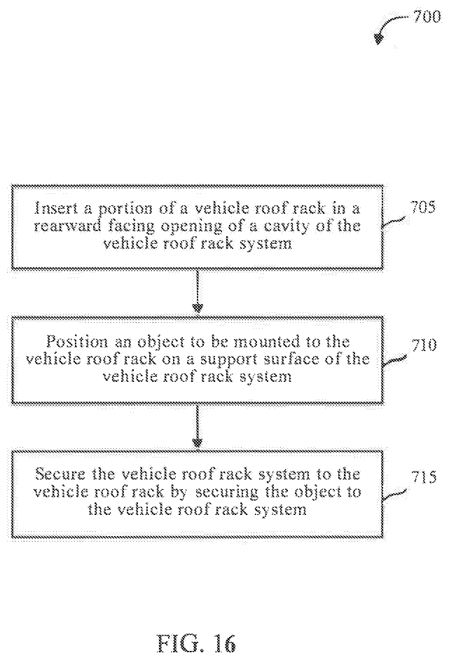

Referring now to FIGS. 9 and 10, another example vehicle roof rack system 300 is shown and described. The vehicle roof rack system 300 includes a body member 310 and a rack attachment member 312. The body member 310 includes horizontal support surfaces 320, 322 (also referred to as top support surfaces), vertical support surfaces 324, 326, a gap 328, retention portions 330, a bottom surface 332, and a handle 334. The rack attachment member 312 includes an attachment end 340, first and second free ends 342, 344, a through bore 346, and lateral gripping protrusions 348. The features and function of at least some aspect of the vehicle roof rack system 300 may be the same or similar to many of the features and functionality of the vehicle roof rack systems 100, 200 described above. One feature of the vehicle roof rack system 300 is the shape and size of the horizontal support surfaces 320, 322. The horizontal support surfaces 320, 322 have a generally contoured shape that may be referred to as a gutter shape or a channel shape. The horizontal support surfaces 320, 322 may be particularly well suited to support a cylindrical-shaped object such as the handle of a paddle or oar, a tube used to store a fishing rod, sports equipment such as a javelin, lacrosse stick, or pole vault pole, construction materials such as pipes, tubes or rods, or tools such as shovels or rake handles. The use of the two horizontal support surfaces 320, 322 may make it possible to support two separate elongate cylindrical-shaped objects positioned side by side. Other embodiments may include a single support surface having a contoured cross-sectional shape and configured to support a single elongate structure having a contoured cross-section or surface.

Other embodiments may include three or more separate support surfaces similar in shape and/or size to the surfaces 320, 322. For example, the area of the vertical support surfaces 324, 326 and gap 328 may be replaced with another contoured horizontal support surface similar in shape and/or size to the surfaces 320, 322. In another example, the area of the vertical support surfaces 324, 326 and gap 328 may be reconfigured to replace the relatively plainer surfaces 324, 326 with contoured surfaces that more closely match the contoured surfaces of the object inserted into the gap 328.

The support surfaces 320, 322 are shown having a constant radius. Other embodiments may include one or more support surfaces that include a variable radius. Furthermore, upper transition points 323, 325 between respective surfaces 320, 324 and 322, 326 may provide a support surface for other shaped objects that don't necessary mate with the surfaces 320, 322 or within the gap 328. For example, a set of skis could be supported on the transition points 323, 325 when the skis are in a flat, horizontal orientation. In another example, lumber, plywood, molding, doors, or other construction materials or equipment could be supported on the transition points 323, 325 where the material are in a flat, horizontal orientation. Thus, the vehicle roof rack system 300 may accommodate a variety of different sized and shaped objects.

FIG. 11 shows another example vehicle roof rack system 400 that includes a body member 410 and a rack attachment member 412. The body member 410 includes horizontal support surfaces 420, 422, vertical support surfaces 424, 426, a gap 428, retention portions 430, a bottom surface 432, a handle 434, and a tire support 436. The rack attachment member 412 includes an attachment end 440, first and second free ends 442, 444, a through bore 446, and lateral gripping protrusions 448. A cavity 452 may be defined between the rack attachment member 412 and the body member 410. The vehicle roof rack system 400 may be well suited to support the wheel of a bike, scooter, or other vehicle. The wheels, in particular a tire portion of the wheel, may be supported on the tire support 436. The tire support 436 may have a groove or channel-like shape. The tire support 436 may be elongate and extend forward or rearward from remaining portions of the body member 410. The tire support 436 may have a cross-sectional shape similar to the shape of support surfaces 320, 322 described above with reference to FIGS. 9 and 10, although other cross-sectional shapes are possible.

The tire support 436 may have a length that is sufficiently long to accommodate vehicles of different lengths and sizes. For example, the tire support 436 may have a length that can accommodate bicycles ranging between a large frame and a youth sized frame. FIG. 11 shows the tire support 436 extending in a rearward direction. In other embodiments, the tire support 436 may also extend in a forward direction, wherein the forward and rearward directions correlate with the front and rear ends of a bicycle.

The cross-sectional shape of the tire support 436 may vary depending on the size and shape of the device supported in the tire support 436. Although the tire support 436 is preferably sized and shaped to accommodate and interface with a tire of a bicycle or other wheeled vehicle, the same structure can be used to support other elongate structures such as a paddle, tent poles, ski poles, trekking poles, fishing rods, fishing rod carrying cases, or other elongate outdoor products. Other embodiments of the vehicle roof rack system disclosed herein may have protruding portions that extend in a forward or rearward direction similar to the tire support 436 that have different cross-sectional shapes and provide similar supporting functions for an object supported by the vehicle roof rack system and intended to be mounted to the vehicle cross-bar.

The connecting strap 114 described above with reference to FIG. 1 can be used with any of the vehicle roof rack system embodiments disclosed herein. Similarly, any desired connecting member that provides a positive connection between the object intended to be mounted to the vehicle and to the vehicle roof rack system are possible. It may be possible in some arrangements to position two vehicle roof rack systems arranged side-by-side and a single connecting member used for both of the vehicle roof rack systems. Further, the connecting members may have various lengths as well as cross-sectional shapes, buckle or other fastener features, and the like. Various length connecting members may be used for different objects that are to be supported by a vehicle roof rack system, or to be used with two or more vehicle roof rack systems that are positioned adjacent to each other.

FIGS. 12 and 13 illustrate use of a pair of vehicle roof rack systems 100 with a pair of vehicle cross-bars 104 on a vehicle roof 102. Initially, the vehicle roof rack systems 100 are mounted to the cross-bars 104 by sliding the vehicle roof rack system 100 onto the cross-bars 104 (i.e., the cross-bars 104 are inserted into the cavities 152). An object to be mounted to the vehicle (e.g., a set of skis 106 or other sports-related equipment) is then positioned on one of the support surfaces of the body members 110. FIG. 12 shows the skis 106 supported on the horizontal support surface 120 and positioned between the retention portions 130.

FIG. 13 shows a connecting strap 114 inserted into the through bore 146 and wrapped around portions of the skis 106. The free end of the connecting strap is inserted through the buckle 164 and tension is applied to the connecting strap 114 to tighten the connecting strap 114. With the connecting strap 114 tightened, a force is applied that secures skis 106 to the body member 110 and applies a compression force to the cross-bars 104 thereby securing the vehicle roof rack system 100 to the cross-bars 104.

The skis 106 can be removed from the vehicle and the vehicle roof rack system 100 by releasing the connecting straps 114. Releasing the connecting straps 114 disconnects the skis 106 from the body member 110 and releases the compressive force on the cross-bars 104 such that the vehicle roof rack system 100 can be easily slid off from the cross-bars 104. The vehicle roof rack system 100 can be removed from the cross-bars 104 and stored when the skis 106 are removed from the vehicle roof 102, such as during use of the skis. The vehicle roof rack system 100 can then be relatively easily mounted again to the cross-bars 104 in order to mount the skis 106 to the cross-bars 104 along the roof 102 at any desired time.

FIG. 14 illustrates shows another example vehicle roof rack system 500 that includes a body member 510 and a rack attachment member 512. The body member 510 includes horizontal support surfaces 520, 522, vertical support surfaces 524, 526, a gap 528, retention portions 530, a bottom surface 532, a handle 534, and a tire support 536. The rack attachment member 512 includes an attachment end 540, first and second free ends 542, 544, a through bore 546, and lateral gripping protrusions 548. A cavity 552 may be defined between the rack attachment member 512 and the body member 510. The vehicle roof rack system 500 may be well suited to support the wheel of a bike, scooter, or other vehicle. The wheels, in particular a tire portion of the wheel, may be supported on the tire support 536. The tire support 536 may have a groove or channel-like shape. The tire support 536 may be elongate and extend forward or rearward from remaining portions of the body member 510. The tire support 536 may have a cross-sectional shape similar to the shape of support surfaces 320, 322 described above with reference to FIGS. 9 and 10, although other cross-sectional shapes are possible.

The tire support 536 may have a length that is sufficiently long to accommodate vehicles of different lengths and sizes. For example, the tire support 536 may have a length that can accommodate bicycles ranging between a large frame and a youth sized frame. FIG. 11 shows the tire support 536 extending in a rearward direction. In other embodiments, the tire support 536 may also extend in a forward direction, wherein the forward and rearward directions correlate with the front and rear ends of a bicycle.

The cross-sectional shape of the tire support 536 may vary depending on the size and shape of the device supported in the tire support 536. Although the tire support 536 is preferably sized and shaped to accommodate and interface with a tire of a bicycle or other wheeled vehicle, the same structure can be used to support other elongate structures such as a paddle, tent poles, ski poles, trekking poles, fishing rods, fishing rod carrying cases, or other elongate outdoor products. Other embodiments of the vehicle roof rack system disclosed herein may have protruding portions that extend in a forward or rearward direction similar to the tire support 536 that have different cross-sectional shapes and provide similar supporting functions for an object supported by the vehicle roof rack system and intended to be mounted to the vehicle cross-bar.

The connecting strap 114 described above with reference to FIG. 1 can be used with any of the vehicle roof rack system embodiments disclosed herein. Similarly, any desired connecting member that provides a positive connection between the object intended to be mounted to the vehicle and to the vehicle roof rack system are possible. It may be possible in some arrangements to position two vehicle roof rack systems arranged side-by-side and a single connecting member used for both of the vehicle roof rack systems. Further, the connecting members may have various lengths as well as cross-sectional shapes, buckle or other fastener features, and the like. Various length connecting members may be used for different objects that are to be supported by a vehicle roof rack system, or to be used with two or more vehicle roof rack systems that are positioned adjacent to each other.

FIG. 14 illustrates use of two pairs of vehicle roof rack systems 500 with a pair of vehicle cross-bars 104 on a vehicle roof 102. Initially, the vehicle roof rack systems 500 are mounted to the cross-bars 104 by sliding the vehicle roof rack systems 500 onto the cross-bars 104 (i.e., the cross-bars 104 are inserted into the cavities 552). An object to be mounted to the vehicle (e.g., a board or beam 506 or other construction material, equipment, tool, or the like) is then positioned on one of the support surfaces of the body members 110. FIG. 14 shows the object 506 supported on the cross-bars 104 and positioned between the roof rack systems 500. In other embodiments, the object 506 may rest upon a portion of one of more of the roof rack systems 500, such as on a portion of a body member 510 or a support portion 511.

A connecting strap 114 inserted into the through bore 546 and wrapped around portions of the object 506. The free end of the connecting strap is inserted through the buckle 164 and tension is applied to the connecting strap 114 to tighten the connecting strap 114. With the connecting strap 114 tightened, a force is applied that secures object 506 to the cross-bars 104.

The object 506 can be removed from the vehicle and the vehicle roof rack system 500 by releasing the connecting straps 114. Releasing the connecting straps 114 disconnects the object 506 from the cross-bars 104 such that the vehicle roof rack system 500 can be easily slid off from the cross-bars 104.

FIG. 15 illustrates an example method 600 of securing a vehicle roof rack system to a vehicle cross-bar or other feature of the vehicle. The method 600 may be used in association with any of the vehicle roof rack systems 100, 200, 300, 400, 500 described above with reference to the figures.

Method 600 may include, at block 605, positioning a portion of a vehicle roof rack in a cavity of roof rack system. The portion of the vehicle roof rack may include, for example, a laterally extended cross-bar such as the cross-bar 104 shown in FIGS. 12 and 13. At block 610, the method 600 includes positioning an object on a support surface of the vehicle roof rack system. The object may include, for example, a set of skis 106 as shown and described above with reference to FIGS. 12 and 13. At block 615, the method 600 includes securing the object to the vehicle roof rack system with a connecting member. Block 620 includes simultaneously releasably securing the vehicle roof rack system to the vehicle cross-bars with the connecting member.

The method 600 may also include providing the vehicle roof rack system with a body member, a rack attachment member, and a connecting member, the rack attachment member extending from the body member to define the cavity, the connecting member connecting to a free end of the rack attachment member, and securing the object to the vehicle roof rack system includes wrapping the connecting member around the object and applying tension force. The method 600 may also include applying the tension force to releasably secure the vehicle roof rack system to the vehicle cross-bars and releasing the tension permits the vehicle roof rack system to be detached from the vehicle cross-bars. The connecting member may include a strap and an adjustable buckle, and tightening the strap with the adjustable buckle applies a tension force. The cavity may be open in a direction facing rearward when the vehicle roof rack system is mounted to the vehicle cross-bars.

FIG. 16 illustrates another example method 700 related to mounting a vehicle roof rack system to a vehicle cross-bar. The method 700 may be applicable to any of the vehicle roof rack systems 100, 200, 300, 400, 500 described above with reference to the figures.

The method 700 may include, at block 705, inserting a portion of a vehicle cross-bar in a rearward facing opening of a cavity of a vehicle roof rack system. The method 700 may include positioning an object to be mounted to the vehicle cross-bar on a support surface of the vehicle roof rack system. The method 700 may include, at block 715, the step of securing the vehicle roof rack system to the vehicle cross-bars by securing the object to the vehicle roof rack system.

Securing the object to the vehicle roof rack system may include wrapping a connecting member around a portion of the object and securing the connecting member to a portion of the vehicle roof rack system. Securing the object to the vehicle roof rack system may include tightening a connecting member, the connecting member including a releasable bracket or a buckle. The bracket or buckle may include a quick release function, ratchet, or other feature that promotes application of a tension force and/or releases the tension force.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” as may be used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (e.g., A and B and C).

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A vehicle roof rack system comprising:
a body member having at least one support surface arranged to support an object to be mounted to a vehicle;
a flexible rack attachment member extending from the body member, a cavity being defined between the body member and the rack attachment member, the cavity being sized to removably receive a portion of cross-bar of the vehicle;
a connecting strap connected to the rack attachment member and configured to wrap around the object supported on the at least one support surface, wherein tightening the connecting strap flexes the rack attachment member to apply a compression force that secures the vehicle roof rack system to the cross-bar.

2. The vehicle roof rack system of claim 1, wherein the connecting strap includes a quick release or adjustable buckle.

3. The vehicle roof rack system of claim 1, wherein the cavity has a U cross-sectional shape.

4. The vehicle roof rack system of claim 1, wherein the at least one support surface includes at least one planar surface and the object is at least one set of snow skis or at least one snowboard.

5. The vehicle roof rack system of claim 1, wherein the at least one support surface includes at least one contoured surface and the object is one of an oar, a grippable handle, a pole, a pipe, or a tube.

6. The vehicle roof rack system of claim 1, wherein the at least one support surface is sized and configured to support a bicycle tire or a bicycle wheel and the object is a bicycle.

7. The vehicle roof rack system of claim 1, wherein the at least one support surface is sized and configured to support a fishing rod or fishing rod case.

8. The vehicle roof rack system of claim 1, wherein the body member and rack attachment member comprise polycarbonate.

9. The vehicle roof rack system of claim 1, wherein the body member and rack attachment member have an integral, single piece construction.

10. The vehicle roof rack system of claim 1, wherein the rack attachment member includes a plurality of elongate gripping protrusions.

11. The vehicle roof rack system of claim 1, wherein the rack attachment member includes at least one through bore, the connecting strap extending through the at least one through bore.

12. The vehicle roof rack system of claim 1, wherein the rack attachment member includes a first end connected to the body member and a second free end spaced apart from the body member at an opening into the cavity.

13. The vehicle roof rack system of claim 12, wherein the rack attachment member includes at least one through bore positioned at the second free end, the connecting strap extending through the at least one through bore.

14. The vehicle roof rack system of claim 1, wherein the at least one support surface includes first and second support surfaces spaced apart laterally from each other.

15. The vehicle roof rack system of claim 14, wherein the body member includes retention portions positioned adjacent to the at least one support surface and arranged to restrict lateral movement of the object supported on the at least one support surface.

16. A vehicle roof rack system comprising:
a body member having at least one support surface arranged to support an object to be mounted to a vehicle;
a rack attachment member having a first end connected to the body member and a second end spaced apart from the body member to define a cavity between the body member and the rack attachment member, the cavity configured to receive a cross-bar of the vehicle;
a connecting member connected to the rack attachment member and configured to engage the object supported on the at least one support surface, wherein the connecting member applies a force that secures the object to the vehicle roof rack system and secures the vehicle roof rack system to the cross-bar.

17. A method of mounting an object to a vehicle roof rack system, comprising:
positioning a portion of a vehicle cross-bar in a cavity of the vehicle roof rack system;
positioning the object on a support surface of the vehicle roof rack system;
securing the object to the vehicle roof rack system with a connecting member and simultaneously releasably securing the vehicle roof rack system to the vehicle cross-bar with the connecting member.

18. The method of claim 17, wherein the vehicle roof rack system includes a body member, a rack attachment member, and a connecting member, the rack attachment member extending from the body member to define the cavity, the connecting member connected to a free end of the rack attachment member, and securing the object to the vehicle roof rack system includes wrapping the connecting member around the object and applying a tension force.

19. The method of claim 17, wherein applying the tension force releasably secures the vehicle roof rack system to the vehicle cross-bar, and releasing the connecting member permits the vehicle roof rack system to be detached from the vehicle cross-bar.

20. The method of claim 17, wherein the connecting member includes a strap and adjustable buckle, and tightening the strap with the adjustable buckle applies a tension force.
